(19) United States
(12) Patent Application Publication
(10) Pub. No.: US 2025/0091245 A1
(43) Pub. Date: Mar. 20, 2025

(54) 3D SCREEN PRINTING PRINTER AND 3D SCREEN PRINTING METHOD

(71) Applicant: Siemens Energy Global GmbH & Co. KG, Munich, Bayern (DE)

(72) Inventors: Reiner Anton, Berlin (DE); Holger Grote, Mülheim (DE)

(73) Assignee: Siemens Energy Global GmbH & Co. KG, Munich, Bayern (DE)

(21) Appl. No.: 18/729,575

(22) PCT Filed: Dec. 21, 2022
(86) PCT No.: PCT/EP2022/087172

§ 371 Date: Jul. 17, 2024

(30) Foreign Application Priority Data
Jan. 25, 2022 (DE) 10 2022 200 764.6

(51) Int. Cl. B28B 1/00; B33Y 10/00; B33Y 30/00; B41F 15/08; B41F 15/36; C04B 35/626; C04B 35/64

(52) U.S. Cl. CPC B28B 1/001; B33Y 10/00; B33Y 30/00; B41F 15/08; B41F 15/36; C04B 35/62655; C04B 35/64; C04B 2235/6026; C04B 2235/604

(57) ABSTRACT

A 3D screen printing printer for producing a component includes a first and second roll which are spaced apart and a printing plate secured to the first and second roll, is wound on the first roll, has a plurality of portions located side by side in the longitudinal direction and each have a stencil for a particular layer of the component. The first and second roll rotate and unwind the printing plate from the first roll and onto the second roll, and the printing plate is transported from the first to the second roll. The printing plate has a part which is tensioned by the first and second roll and extends in the movement direction from the first to the second roll. The longitudinal direction of the tensioned part coincides with the movement direction and the 3D screen printing printer pushes a printing paste through the tensioned part.

### CROSS REFERENCE TO RELATED APPLICATIONS

This application is the US National Stage of International Application No. PCT/EP2022/087172 filed 21 Dec. 2022, and claims the benefit thereof, which is incorporated by reference herein in its entirety. The International Application claims the benefit of German Application No. DE 10 2022 200 764.6 filed 25 Jan. 2022.

### FIELD OF INVENTION

The invention relates to a 3D screen printing printer and method for producing a component.

### BACKGROUND OF INVENTION

In a 3D screen printing method, a component is produced by building it up layer by layer. This involves, for each layer, pressing a printing paste through a printing form having a screen printing screen and a template. If the component has changing cross sections, it is necessary to use different printing forms for different layers. However, this is cumbersome.

### SUMMARY OF INVENTION

It is therefore an object of the invention to provide a 3D screen printing printer and a 3D screen printing method which can be used to produce a component in a simple manner.

The 3D screen printing printer according to the invention for producing a component comprises a first roll and a second roll, which are spaced apart from one another, and a printing form which is fastened to the first roll and to the second roll, is wound up on the first roll, has a longitudinal direction and comprises a plurality of portions which are arranged next to one another in the longitudinal direction and each have a template for a respective layer of the component, wherein the first roll and the second roll are configured to rotate and thus to unwind the printing form from the first roll and wind it up onto the second roll, as a result of which the printing form is transported in a movement direction from the first roll to the second roll, wherein the printing form has a part which is stretched by the first roll and the second roll and extends in the movement direction from the first roll up to the second roll, wherein the longitudinal direction of the stretched part coincides with the movement direction and the 3D screen printing printer is configured to press a printing paste through the stretched part.

The 3D screen printing method according to the invention for producing a component comprises the steps: a) providing a printing form which has a longitudinal direction and comprises a plurality of portions which are arranged next to one another in the longitudinal direction and each have a template for a respective layer of the component; b) providing a first roll and a second roll which are spaced apart from one another; c) fastening the printing form to the first roll and to the second roll and winding the printing form onto the first roll, such that the printing form has a part which is stretched by the first roll and the second roll and extends from the first roll up to the second roll; d) arranging one of the portions in the stretched part; e) pressing a printing paste through the portion arranged in the stretched part, as a result of which a first one of the layers is applied; f) rotating the first roll and the second roll in such a way that the printing form is unwound from the first roll and wound up onto the second roll; g) pressing the printing paste through another of the portions which is arranged in the stretched part and through which no printing paste has yet been pressed in the production of the component, as a result of which a further one of the layers is applied.

The 3D screen printing printer according to the invention and the 3D screen printing method according to the invention make it possible to change the templates in a simple manner by rotating the first roll and the second roll. This makes it possible to produce the component in a simple manner.

It is preferable for at least two of the templates to have a different form. This makes it possible for at least two of the layers of the component to be produced with a different cross section.

It is preferable for the printing paste to be a ceramic printing paste.

The printing form preferably comprises a screen printing screen. The templates are preferably formed from a sheet material, in particular a plastics sheet material. The screen printing screen may be formed by the sheet material. As an alternative, it is conceivable for the screen printing screen to be a component which is separate from the sheet material and for the templates to be fastened to the screen printing screen.

It is preferable for the method to comprise the step: h) drying the layer applied in step g) before a further one of the layers is applied. In addition, the method preferably comprises the step: e1) drying the layer applied in step e) before a further one of the layers is applied.

In step e), the first one of the layers is preferably applied to a platform and the method preferably comprises the step: i) moving the platform, in particular downward. In the event that step h) is carried out, step i) may be carried out, for example, before or after step h). In addition, the method comprises the step: e2) moving the platform, in particular downward, before a further one of the layers is applied.

It is preferable for the method to comprise the step: j) repeating steps f) and g), and optionally step h) and optionally step i), at least once.

Step a) preferably comprises the step: a1) virtually segmenting the component into virtual layers, wherein the first one of the layers and the further ones of the layers each correspond to one of the virtual layers.

In addition, step a) preferably comprises the step: a2) producing the respective template by stamping and/or laser cutting of a sheet material. In step a2), a screen printing screen is preferably formed from the sheet material by the stamping and/or the laser cutting. As an alternative, it is conceivable for step a) to preferably comprise the step: a3) attaching the sheet material to a screen printing screen, as a result of which the printing form is produced. Step a3) may be effected after step a2) or before step a2). The sheet material may, for example, be a plastics sheet material.

The method preferably comprises the step: k) sintering the layers. For example, the component may be completed by the sintering, however further processing steps, such as grinding, are conceivable.

### BRIEF DESCRIPTION OF THE DRAWINGS

The invention will be explained in more detail below on the basis of the attached schematic drawings, in which:

FIG. 1 shows a perspective view of part of a 3D screen printing printer, and

FIG. 2 shows a section through the 3D screen printing printer.

### DETAILED DESCRIPTION OF INVENTION

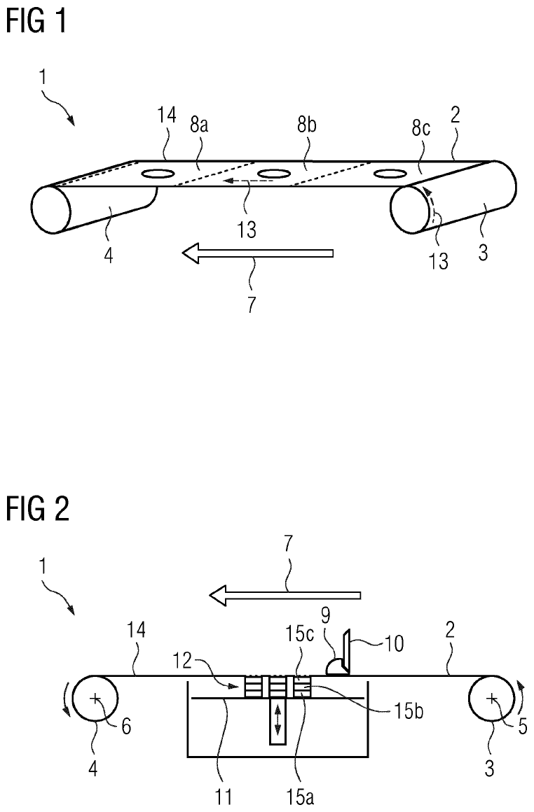

As can be seen from FIGS. 1 and 2, a 3D screen printing printer 1 for producing a component 12 comprises a first roll 3 and a second roll 4 which are spaced apart from one another. In addition, the 3D screen printing printer 1 comprises a printing form 2 which is fastened to the first roll 3 and to the second roll 4, is wound up on the first roll 3, has a longitudinal direction 13 and comprises a plurality of portions 8a, 8b, 8c which are arranged next to one another in the longitudinal direction 13. The portions 8a, 8b, 8c are illustrated separately from one another in FIG. 1 by way of the dashed lines. The portions 8a, 8b, 8c each have a template for a respective layer 15a, 15b, 15c of the component 12. The first roll 3 and the second roll 4 are configured to rotate and thus to unwind the printing form 2 from the first roll 3 and wind it up onto the second roll 4, as a result of which the printing form 2 is transported in a movement direction 7 from the first roll 3 to the second roll 4. The printing form 2 has a part 14 which is stretched by the first roll 3 and the second roll 4 and extends in the movement direction 7 from the first roll 3 up to the second roll 4. The longitudinal direction 13 of the stretched part 14 coincides with the movement direction 7. The 3D screen printing printer 1 is configured to press a printing paste 9 through the stretched part 14.

FIG. 1 shows that at least two of the templates may have a different form. It is also conceivable for at least three of the templates or at least ten of the templates or at least a hundred of the templates to have a different form.

The printing form 2 may comprise a screen printing screen. The screen printing screen may be formed by the templates, in particular the sheet material, or may be a component which is separate from the templates and on which the templates are arranged.

The printing paste 9 may be a ceramic printing paste 9.

FIG. 2 shows that the first roll 3 may be configured to rotate about a first axis of rotation 5, which runs through the first roll 3, in particular the first axis of rotation 5 coincides with a centroidal axis of the first roll 3. In addition, FIG. 2 shows that the second roll 4 may be configured to rotate about a second axis of rotation 6, which runs through the second roll 4, in particular the second axis of rotation 6 coincides with a centroidal axis of the second roll 4.

FIGS. 1 and 2 show that the stretched part 14 may be arranged completely in a horizontal plane. The 3D screen printing printer 1 may comprise a doctor blade 10 (see FIG. 2), which is configured to press the printing paste 9 through the stretched part 14. The doctor blade 10 may, for example, be configured to be moved in the longitudinal direction 13 of the stretched part 14. In addition, the doctor blade 10 may be arranged above the stretched part 14 and thus be configured to press the printing paste 9 from above downward through the stretched part 14.

As can be seen from FIG. 2, the 3D screen printing printer 1 may comprise a platform 11 and the 3D screen printing printer 1 may be configured to apply the layers 15a, 15b, 15c to the platform 11. The platform 11 may be arranged in the 3D screen printing printer 1 so as to be movable, in particular so as to be vertically movable. In addition, the platform 11 may be arranged below the stretched part 14.

The first roll 3 and/or the second roll 4 may be configured to be rotated by hand. As an alternative or in addition, it is conceivable for the 3D screen printing printer 1 to comprise a motor, in particular an electric motor, which is configured to rotate the first roll 3 and/or the second roll 4.

The 3D screen printing method for producing a component 12 may comprise the steps: a) providing a printing form 2 which has a longitudinal direction 13 and comprises a plurality of portions 8a, 8b, 8c which are arranged next to one another in the longitudinal direction 13 and each have a template for a respective layer 15a, 15b, 15c of the component 12; b) providing a first roll 3 and a second roll 4 which are spaced apart from one another; c) fastening the printing form 2 to the first roll 3 and to the second roll 4 and winding the printing form 2 onto the first roll, such that the printing form 2 has a part 14 which is stretched by the first roll 3 and the second roll 4 and extends from the first roll 3 up to the second roll 4; d) arranging one of the portions 8a in the stretched part 14; e) pressing a printing paste 9 through the portion 8a arranged in the stretched part 14, as a result of which a first one of the layers 15a is applied; f) rotating the first roll 3 and the second roll 4 in such a way that the printing form 2 is unwound from the first roll 3 and wound up onto the second roll 4; g) pressing the printing paste 9 through another of the portions 8b, 8c which is arranged in the stretched part 14 and through which no printing paste 9 has yet been pressed in the production of the component 12, as a result of which a further one of the layers 15b, 15c is applied.

In step f), the printing form 2 may, for example, be transported by the length of one of the portions 8a, 8b, 8c in a movement direction 7 from the first roll 3 to the second roll 4.

The method may comprise the step: h) drying the layer 15b, 15c applied in step g) before a further one of the layers 15b, 15c is applied. In addition, the method may comprise the step: e1) drying the layer applied in step e) before a further one of the layers is applied.

In step e), the first one of the layers 15a may be applied to a platform 11 and the method may comprise the step: i) moving the platform 11 vertically downward. In addition, the method may comprise the step: c2) moving the platform 11, in particular downward, before a further one of the layers 15b, 15c is applied.

The method may comprise the step: j) repeating steps f) and g), and optionally step h) and optionally step i), at least once.

Step a) may comprise the step: a1) virtually segmenting the component 12 into virtual layers, wherein the first one of the layers 15a and the further ones of the layers 15b, 15c each correspond to one of the virtual layers. In addition, step a) may comprise the step: a2) producing the respective template by stamping and/or laser cutting of a sheet material. Furthermore, step a) may comprise the step: a3) attaching the sheet material to a screen printing screen.

In addition, the method may comprise the step: k) sintering the layers 15a, 15b, 15c.

1. A 3D screen printing printer for producing a component, comprising:
a first roll and a second roll, which are spaced apart from one another, and
a printing form which is fastened to the first roll and to the second roll, is wound up on the first roll, has a longitudinal direction and comprises a plurality of portions which are arranged next to one another in the longitudinal direction and each have a template for a respective layer of the component,
wherein the first roll and the second roll are configured to rotate and thus to unwind the printing form from the first roll and wind it up onto the second roll, as a result of which the printing form is transported in a movement direction from the first roll to the second roll,
wherein the printing form has a part which is stretched by the first roll and the second roll and extends in the movement direction from the first roll up to the second roll,
wherein the longitudinal direction of the stretched part coincides with the movement direction and the 3D screen printing printer is configured to press a printing paste through the stretched part.

2. The 3D screen printing printer as claimed in claim 1,
wherein at least two of the templates have a different form.

3. The 3D screen printing printer as claimed in claim 1,
wherein the printing paste is a ceramic printing paste.

4. The 3D screen printing printer as claimed in claim 1,
wherein the printing form comprises a screen printing screen.

5. A 3D screen printing method for producing a component, comprising:
a) providing a printing form which has a longitudinal direction and comprises a plurality of portions which are arranged next to one another in the longitudinal direction and each have a template for a respective layer of the component;
b) providing a first roll and a second roll which are spaced apart from one another;
c) fastening the printing form to the first roll and to the second roll and winding the printing form onto the first roll, such that the printing form has a part which is stretched by the first roll and the second roll and extends from the first roll up to the second roll;
d) arranging one of the portions in the stretched part;
e) pressing a printing paste through the portion arranged in the stretched part, as a result of which a first one of the layers is applied;
f) rotating the first roll and the second roll in such a way that the printing form is unwound from the first roll and wound up onto the second roll;
g) pressing the printing paste through another of the portions which is arranged in the stretched part and through which no printing paste has yet been pressed in the production of the component, as a result of which a further one of the layers is applied.

6. The 3D screen printing method as claimed in claim 5, further comprising:
h) drying the layer applied in step g) before a further one of the layers is applied.

7. The 3D screen printing method as claimed in claim 6,
wherein, in step e), the first one of the layers is applied to a platform; and further comprising:
i) moving the platform, in particular downward.

8. The 3D screen printing method as claimed in claim 7, further comprising:
j) repeating steps f) and g), and optionally repeating step h) and optionally repeating step i), at least once.

9. The 3D screen printing method as claimed in claim 5,
wherein step a) comprises:
a1) virtually segmenting the component into virtual layers, wherein the first one of the layers and the further ones of the layers each correspond to one of the virtual layers.

10. The 3D screen printing method as claimed in claim 5,
wherein step a) comprises:
a2) producing the respective template by stamping and/or laser cutting of a sheet material.

11. The 3D screen printing method as claimed in claim 10,
wherein, in step a2), a screen printing screen is formed from the sheet material by the stamping and/or the laser cutting.

12. The 3D screen printing method as claimed in claim 10,
wherein step a) comprises:
a3) attaching the sheet material to a screen printing screen.

13. The 3D screen printing method as claimed in claim 5,
wherein the printing paste is a ceramic printing paste.

14. The 3D screen printing method as claimed in claim 8, further comprising:
k) sintering the layers.
